(19) United States
(12) Patent Application Publication
(10) Pub. No.: US 2024/0308062 A1
(43) Pub. Date: Sep. 19, 2024

(54) INFORMATION PROCESSING APPARATUS, ROBOT SYSTEM, AND INFORMATION PROCESSING METHOD

(71) Applicant: CANON KABUSHIKI KAISHA, Tokyo (JP)

(72) Inventor: HIRONOBU SASAKI, Kanagawa (JP)

(21) Appl. No.: 18/594,722

(22) Filed: Mar. 4, 2024

(30) Foreign Application Priority Data
Mar. 15, 2023 (JP) 2023-040537

(51) Int. Cl. B25J 9/00; B25J 9/16; B25J 13/00; B25J 19/02

(52) U.S. Cl. CPC B25J 9/0081; B25J 9/1664; B25J 9/1682; B25J 13/006; B25J 19/023

(57) ABSTRACT

An information processing apparatus includes an information processing portion. The information processing portion is configured to send first information to an operating device if the operating device is connected to the information processing apparatus. The first information is information on a motion of a first robot that may be a target robot to be operated by the operating device.

### BACKGROUND OF THE INVENTION

### Field of the Invention

The present disclosure relates to a technology on robots.

### Description of the Related Art

In a factory, a plurality of robots is used for manufacturing products. Each of the plurality of robots is controlled by a corresponding one of a plurality of controllers. The plurality of controllers may be used in a standalone environment in which the controllers are not connected with each other, or may be used in a network environment in which the controllers are connected with each other.

When an operator, or a user, teaches a target robot of the plurality of robots, it is necessary for the user to connect a teaching pendant to a controller connected with the target robot.

The controller and the teaching pendant may be connected with each other by using a wired connection method, via a cable or the like, or by using a wireless connection method, via a wireless communication apparatus or the like. If the teaching pendant is connected to the target controller by using any one of the connection methods, the user can remotely control the target robot by using the teaching pendant. Thus, the user has to find the controller connected with the target robot, from among the plurality of controllers.

Japanese Patent Application Publication No. 2008-080474 discloses a technique for establishing the connection between a teaching pendant and a controller. In this technique, the teaching pendant requests a reply of identification numbers from a plurality of controllers. The teaching pendant then obtains the identification numbers, and displays the identification numbers on a liquid crystal display. If a user selects an identification number from among the plurality of identification numbers, the teaching pendant sends an address of the teaching pendant, to a controller that corresponds to the identification number selected by the user. In this manner, the connection between the teaching pendant and the controller is established.

### SUMMARY OF THE INVENTION

According to one aspect of the present disclosure, an information processing apparatus includes an information processing portion. The information processing portion is configured to send first information to an operating device if the operating device is connected to the information processing apparatus. The first information is information on a motion of a first robot that may be a target robot to be operated by the operating device.

Further features of the present invention will become apparent from the following description of exemplary embodiments with reference to the attached drawings.

### BRIEF DESCRIPTION OF THE DRAWINGS

FIG. 1 is a diagram illustrating a configuration of a robot system of a first embodiment.

FIG. 2 is a diagram illustrating a robot of the first embodiment.

FIG. 3 is a block diagram illustrating a control system of the robot system of the first embodiment.

FIG. 4A is a functional block diagram of a controller of the first embodiment.

FIG. 4B is a functional block diagram of a teaching pendant of the first embodiment.

FIG. 5 is a flowchart of an information processing method of the first embodiment.

FIG. 6A is a diagram illustrating the information processing method of the first embodiment.

FIG. 6B is a diagram illustrating the information processing method of the first embodiment.

FIG. 7A is a diagram illustrating a first modification of the first embodiment.

FIG. 7B is a diagram illustrating a second modification of the first embodiment.

FIG. 7C is a diagram illustrating a third modification of the first embodiment.

FIG. 8 is a diagram illustrating a robot system of a second embodiment.

FIG. 9 is a diagram illustrating a robot system of a third embodiment.

FIG. 10 is a diagram illustrating a robot system of a fourth embodiment.

FIG. 11 is a flowchart of an information processing method of the fourth embodiment.

FIG. 12 is a diagram illustrating an example of an image displayed on a teaching pendant of the fourth embodiment.

FIG. 13 is a diagram illustrating a robot system of a fifth embodiment.

FIG. 14 is a block diagram illustrating a control system of the robot system of the fifth embodiment.

FIG. 15 is a flowchart of an information processing method of the fifth embodiment.

FIG. 16 is a flowchart illustrating a procedure for establishing the wireless communication of the fifth embodiment.

FIG. 17 is a diagram illustrating an image displayed on a teaching pendant of the fifth embodiment.

### DESCRIPTION OF THE EMBODIMENTS

It may be difficult for a user to intuitively recognize which robot an identification number displayed on the liquid crystal display is actually associated with. The present disclosure provides an advantageous technology for a user to intuitively identify a target robot to be operated.

Hereinafter, example embodiments of the present disclosure will be described in detail with reference to the accompanying drawings.

### First Embodiment

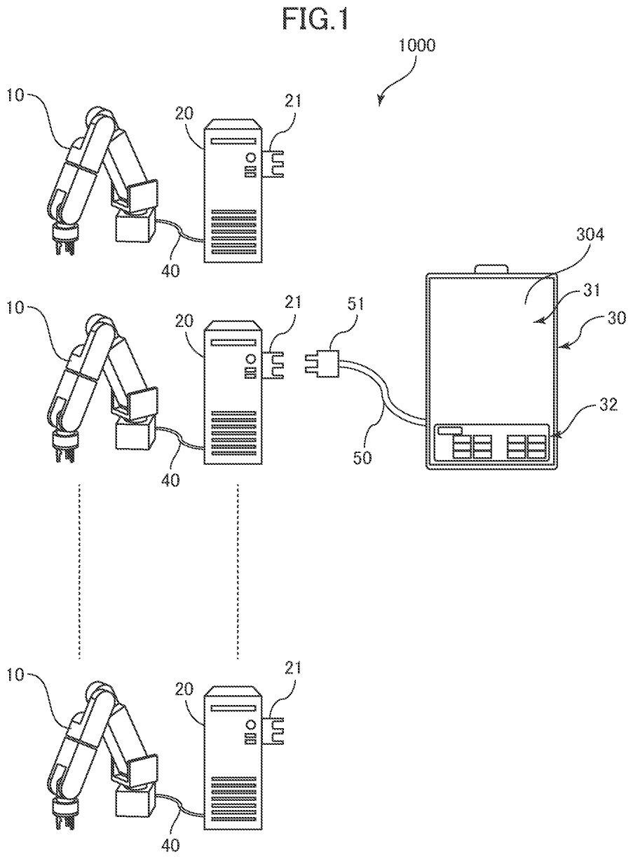

FIG. 1 is a diagram illustrating a configuration of a robot system 1000 of a first embodiment. The robot system 1000 includes a plurality of robots 10, a plurality of controllers 20, and a teaching pendant 30 that is one example of operating devices. The plurality of controllers 20 may be used in a standalone environment in which the controllers 20 are not connected with each other, or may be used in a network environment in which the controllers 20 are connected with each other. The following description will be made, as an example, for the case where the plurality of controllers 20 is used in the standalone environment.

Each of the plurality of controllers 20 controls a corresponding one of the plurality of robots 10. That is, each of the plurality of controllers 20 is connected with a corresponding one of the plurality of robots 10 on a one-to-one basis. Each of the robots 10 is an industrial robot, and is a so-called manipulator. Each of the controllers 20 is one example of information processing apparatuses.

The teaching pendant 30 is an operating device for operating a target robot 10 to be operated. The teaching pendant 30 can be selectively connected to any one of the plurality of controllers 20. Each of the plurality of controllers 20 includes a connection terminal 21. In the first embodiment, the state where the teaching pendant 30 is connected to a controller 20 is a state where the teaching pendant 30 is connected to the connection terminal 21 of the controller 20 via wire.

The following description will be made for a single robot 10 and a single controller 20 that corresponds to the single robot 10. The single robot 10 is one example of a first robot. The robot 10 and the controller 20 are connected to each other via a cable 40 or the like so that they can transmit data to each other.

The teaching pendant 30 can be connected to the connection terminal 21 of the controller 20 via wire. In the first embodiment, a cable 50 that includes a connection terminal 51 is connected to the teaching pendant 30. The connection terminal 51 of the cable 50 is attached to the connection terminal 21 of the controller 20, so that the teaching pendant 30 is electrically and mechanically connected to the controller 20. Thus, the teaching pendant 30 and the controller 20 connected with the teaching pendant 30 can transmit data to each other via the cable 50. Note that the cable 50 may be detachably attached to the teaching pendant 30.

The controller 20 is a robot controller for controlling the motion of the robot 10, and is a computer, for example. The controller 20 can selectively perform an automatic mode or a manual mode. In the automatic mode, the controller 20 moves the robot 10 in accordance with trajectory data that is teach data. In the manual mode, the controller 20 moves the robot 10, depending on an instruction from the teaching pendant 30.

In addition, the single teaching pendant 30 is used for the plurality of controllers 20. The teaching pendant 30 can be connected to any one of the plurality of controllers 20.

The teaching pendant 30 is an operating device that can be operated by a user. The teaching pendant 30 has a function that transmits a motion command to the controller 20 if a user operates the teaching pendant 30. In the manual mode, the controller 20 moves the robot 10, depending on a motion command sent by a user operating the teaching pendant 30. Thus, the robot system 1000 is configured so that the robot 10 is moved by a user operating the teaching pendant 30, in accordance with the operation performed on the teaching pendant 30.

The teaching pendant 30 includes a touch panel display 304. The touch panel display 304 serves as an input portion that is an input device, and as a display portion that is a display device. On the touch panel display 304, an image display portion 31 and an operation portion 32 are displayed as a user interface image. Note that the input portion and the display portion may be components separated from each other.

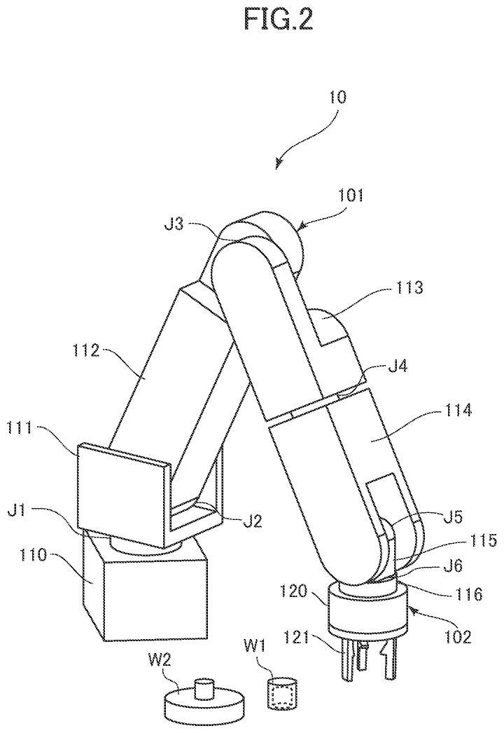

FIG. 2 is a diagram illustrating the robot 10 of the first embodiment. The base end of the robot 10 is a fixed end, and is fixed to a base stand (not illustrated), for example. The distal end of the robot 10 is a free end. The robot 10 includes a robot arm 101, and a robot hand 102 attached to the robot arm 101. The robot hand 102 is one example of end effectors.

The robot arm 101 is a vertically articulated robot arm. The robot arm 101 includes a plurality of joints J1 to J6. The robot arm 101 also includes a base 110 that is a fixed link, and a plurality of links 111 to 116. The base 110 and the links 111 to 116 are linked with each other via the joints J1 to J6, so that the links 111 to 116 can be rotated by the joints J1 to J6.

In each of the joints J1 to J6, a motor is disposed as a power source. The motor, disposed in each of the joints J1 to J6, moves a corresponding one of the joints J1 to J6, that is, a corresponding one of the links 111 to 116, so that the robot 10 can take a variety of postures. Note that although the joints J1 to J6 are rotary joints in the present embodiment, the present disclosure is not limited to this. For example, any of the joints J1 to J6 may be prismatic joints.

The robot hand 102 can hold a workpiece. In the first embodiment, the robot hand 102 includes a hand body 120 that includes a driving source, and a plurality of fingers 121 that are supported by the hand body 120, so that the robot hand 102 can hold a workpiece.

The robot 10 can perform various types of work in a manufacturing line, for manufacturing products. For example, the robot 10 can perform conveyance work by holding a workpiece with the robot hand 102, and assembly work for assembling a workpiece to another workpiece. In addition, the robot 10 can perform machining work for machining a workpiece by using a tool held by the robot 10. In another case, an actuator used for predetermined work in a manufacturing process may be attached to the link 116 of the robot arm 101, for causing the robot 10 to perform the predetermined work.

For example, workpieces W1 and W2 are disposed around the robot 10. The workpiece W1 is held by the robot 10, and assembled to the workpiece W2 by the robot 10, so that a product that is an assembly can be manufactured. The assembly may be an intermediate product or a final product.

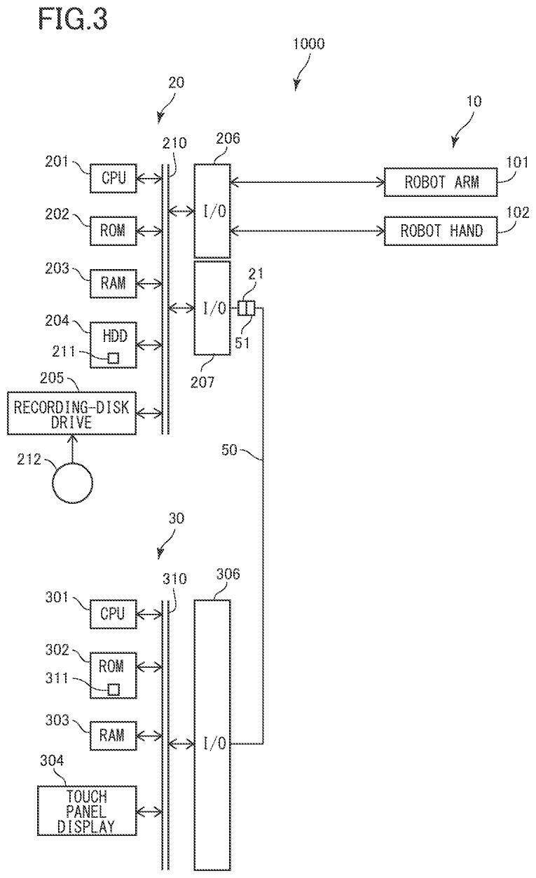

FIG. 3 is a block diagram illustrating a control system of the robot system 1000 of the first embodiment. The following description with reference to FIG. 3 will also be made for the single controller 20 and the single robot 10.

The controller 20 is a computer, and includes a central processing unit (CPU) 201 that is a processor. In addition, the controller 20 includes a read only memory (ROM) 202, a random access memory (RAM) 203, and a hard disk drive (HDD) 204, which serve as storage portions. In addition, the controller 20 includes a recording-disk drive 205, an input/output (I/O) 206, and an I/O 207. Each of the I/Os 206 and 207 is an input/output interface. The CPU 201, the ROM 202, the RAM 203, the HDD 204, the recording-disk drive 205, and the I/Os 206 and 207 are connected with each other via a bus 210 such that they can transmit data to each other.

The ROM 202 stores a base program that is read by the CPU 201 when the computer is started. The RAM 203 is a storage device that is temporarily used in a computing process performed by the CPU 201. The HDD 204 is a storage device that temporarily stores various types of data, such as results of a computing process performed by the CPU 201. In the first embodiment, the HDD 204 stores a program 211 to be executed by the CPU 201. The recording-disk drive 205 reads various types of data and a program stored in a recording disk 212. The robot arm 101 and the robot hand 102 are connected to the I/O 206. The teaching pendant 30 can be connected to the I/O 207 by attaching the connection terminal 51 to the connection terminal 21.

The teaching pendant 30 is a computer, and includes a central processing unit (CPU) 301 that is a processor. The teaching pendant 30 also includes a ROM 302 and a RAM 303, which serve as storage portions. In addition, the teaching pendant 30 includes the touch panel display 304, and an I/O 306 that is an input/output interface. The CPU 301, the ROM 302, the RAM 303, the touch panel display 304, and the I/O 306 are connected with each other via a bus 310 such that they can transmit data to each other.

The ROM 302 stores a program 311 to be executed by the CPU 301. The CPU 301 executes various types of computing processes by executing the program 311. The RAM 303 is a storage device that is temporarily used in a computing process performed by the CPU 301. The I/O 306 can be connected to the I/O 207 of the controller 20 by attaching the connection terminal 51 to the connection terminal 21.

Note that in the controller 20 of the first embodiment, the HDD 204 is a computer-readable non-transitory recording medium and stores the program 211. However, the present disclosure is not limited to this. The program 211 may be recorded in any recording medium as long as the recording medium is a computer-readable non-transitory recording medium. For example, a flexible disk, a hard disk, an optical disk, a magneto-optical disk, a magnetic tape, a nonvolatile memory, or the like may be used as the recording medium that stores the program 211. In another case, the controller 20 may download the program 211 from a server (not illustrated), via a network (not illustrated).

In addition, in the teaching pendant 30 of the first embodiment, the ROM 302 is a computer-readable non-transitory recording medium and stores the program 311. However, the present disclosure is not limited to this. The program 311 may be recorded in any recording medium as long as the recording medium is a computer-readable non-transitory recording medium. For example, a flexible disk, a hard disk, an optical disk, a magneto-optical disk, a magnetic tape, a nonvolatile memory, or the like may be used as the recording medium that stores the program 311. In another case, the teaching pendant 30 may download the program 311 from a server (not illustrated), via a network (not illustrated).

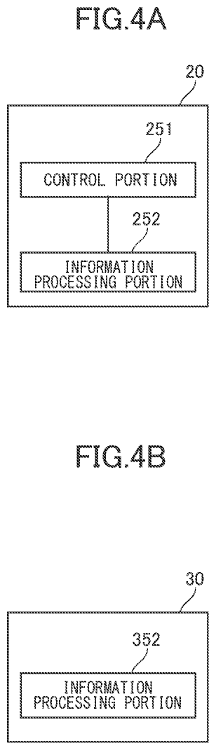

FIG. 4A is a functional block diagram of the controller 20 of the first embodiment. By executing the program 211, the CPU 201 functions as a control portion 251 that can control the robot 10, and as an information processing portion 252 that can perform information processing. FIG. 4B is a functional block diagram of the teaching pendant 30 of the first embodiment. By executing the program 311, the CPU 301 functions as an information processing portion 352 that can perform information processing.

By the way, if an operator, or a user, registers the trajectory data in a controller 20, or adjusts the trajectory data registered in the controller 20, the user connects the teaching pendant 30 to the controller 20 that is of the plurality of controllers 20, and that is connected with the target robot 10. Then, the user remotely controls the robot 10, which corresponds to the controller 20, by operating the teaching pendant 30. Then, the user registers the trajectory data of the robot 10 in the controller 20, or adjusts the trajectory data registered in the controller 20, while watching the motion of the robot 10. The registration of the trajectory data or the adjustment of the registered trajectory data is referred to also as teaching. The trajectory data may be data that includes teach point information and a robot program, or may be time-series displacement data of the joints J1 to J6 of the robot 10.

If the user ends to teach the controller 20 the trajectory data of the robot 10, the teaching pendant 30 is disconnected from the controller 20. Since the single teaching pendant 30 is used for the plurality of controllers 20, the cost for the whole of the robot system 1000 can be reduced.

By the way, the plurality of controllers 20 is often disposed close to each other. Thus, it is difficult for a user to distinguish a controller 20 connected to a robot 10 that the user desires to control remotely, from among the plurality of controllers 20, only by looking at the controllers 20. It might be possible to manage the controllers 20 by using identification numbers. However, it is difficult for a user to intuitively identify the robot 10 that the user desires to control, by using the identification numbers.

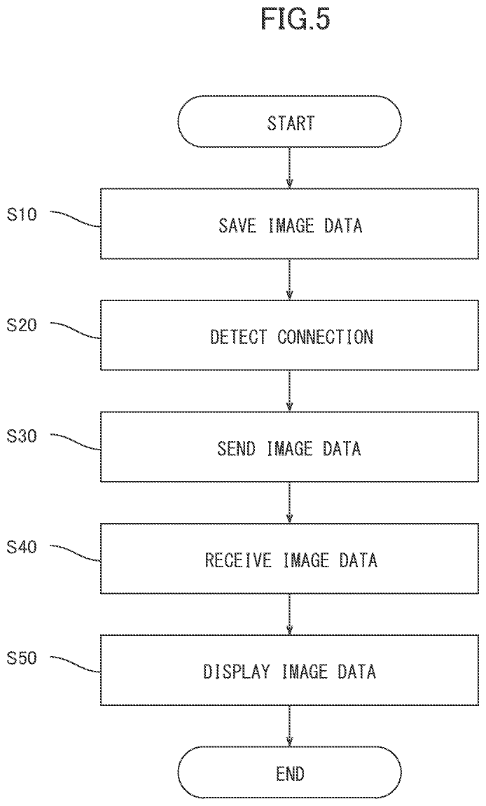

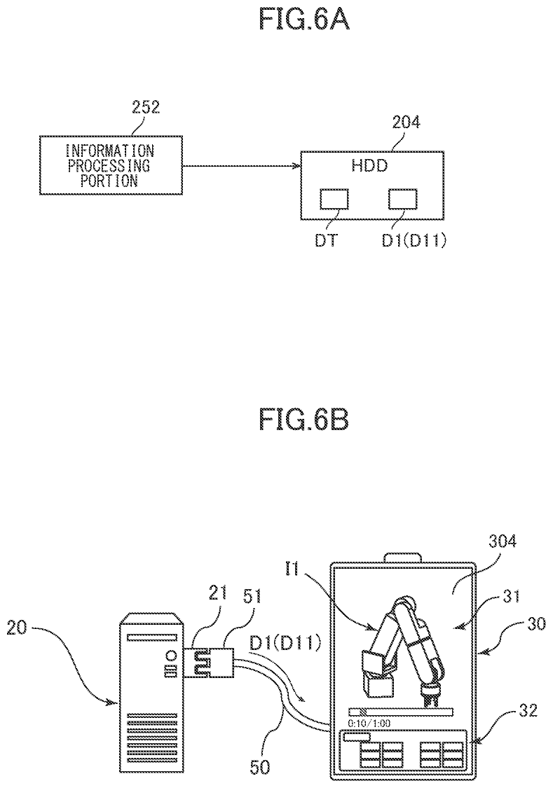

The following description will be made for a case where the trajectory data of the robot 10 has already been registered in the controller 20, that is, the trajectory data of the robot 10 is stored in the HDD 204. FIG. 5 is a flowchart of an information processing method (control method) of the first embodiment. FIG. 6A is a diagram for describing Step S10. In Step S10, the information processing portion 252 registers information D1 in the HDD 204, in advance. The information D1 is one example of first information. Trajectory data DT is registered (stored) in the HDD 204, in advance.

In Step S10, the information processing portion 252 stores the information D1 on the motion of the robot 10, in the HDD 204. The information D1 on the motion of the robot 10 of the first embodiment is image data D11 on the motion of the robot 10. The image data D11 is one example of first image data.

The image data D11 is image data of a 3D model that corresponds to the robot 10. For example, the image data D11 is moving-image data, or an animation, of the 3D model of the robot 10 that moves in accordance with the trajectory data DT. The animation of the motion of the robot 10 is created from the trajectory data DT of the robot 10 and the data of the 3D model of the robot 10. As described above, the trajectory data DT of the robot 10 is, for example, time-series displacement data of the joints J1 to J6 of the robot 10. The time-series displacement data of the joints J1 to J6 of the robot 10 is created from the teach point information of the robot 10 and a robot program. If a plurality of robot programs for the robot 10 is stored in the HDD 204, the information processing portion 252 may use the last robot program used by the control portion 251, for creating the animation of the motion of the robot 10.

FIG. 6B is a diagram for describing Step S20 and the following steps. In Step S20, if the connection terminal 51 of the cable 50 provided to the teaching pendant 30 is connected to the connection terminal 21 of the controller 20, the information processing portion 252 of the controller 20 detects the connection of the teaching pendant 30. The information processing portion 252 may detect the connection of the teaching pendant 30 by using a sensor disposed in the connection terminal 21. In another case, the information processing portion 252 may detect the connection of the teaching pendant 30 by using the plug-and-play function of the USB if the connection terminal 21 is a USB terminal, or may detect the connection of the teaching pendant 30 in the TCP/IP communication or the UDP communication if the connection terminal 21 is an Ethernet (registered trademark) terminal.

In Step S30, if the teaching pendant 30 is connected to the controller 20, the information processing portion 252 of the controller 20 sends the information D1 on the motion of the robot 10 that may be a target robot 10 to be operated by the teaching pendant 30, to the teaching pendant 30. The information D1 is image data D11 in the first embodiment. That is, if the teaching pendant 30 is connected to the controller 20 (the connection serves as a trigger), the information processing portion 252 sends the image data D11 stored in the HDD 204, to the teaching pendant 30. Examples of the method of sending the image data include the serial communication, the TCP/IP communication, and the UDP communication; but the method is not limited to these.

In Step S40, the information processing portion 352 of the teaching pendant 30 receives the information D1, or the image data D11, from the controller 20. The information processing portion 352 of the teaching pendant 30 may store the image data D11, received by the information processing portion 352, in a storage; or may store the image data D11 temporarily in a memory.

In Step S50, the information processing portion 352 of the teaching pendant 30 displays an image I1 that corresponds to the information D1 (the image data D11), on the image display portion 31 of the touch panel display 304. The image I1 is one example of a first image.

In the first embodiment, the information D1, or the image data D11, is moving-image data of a 3D model of the robot 10, based on the trajectory data DT stored in the HDD 204. Thus, the information processing portion 352 displays a moving image, as the image I1, on the image display portion 31 of the touch panel display 304. The moving image is an animation of the robot 10.

As described above, in the first embodiment, a user connects the teaching pendant 30 to a controller 20, and thereby can check the image I1, which corresponds to the information D1 on the motion of a robot 10 connected to the controller 20, by watching the teaching pendant 30. Thus, the user can intuitively determine whether the teaching pendant 30 is connected to a controller 20 connected with a target robot 10 to be operated, by checking the image displayed on the teaching pendant 30. If the user watches the image displayed on the teaching pendant 30, and the robot 10 connected to the controller 20 is the target robot 10 to be operated, the user can directly operate the robot 10 and adjust the trajectory data DT by using the teaching pendant 30. If the user watches the image displayed on the teaching pendant 30, and the robot 10 connected to the controller 20 is not the target robot 10 to be operated, the user can disconnect the teaching pendant 30 from the controller 20, and connect the teaching pendant 30 to another controller 20.

### First Modification

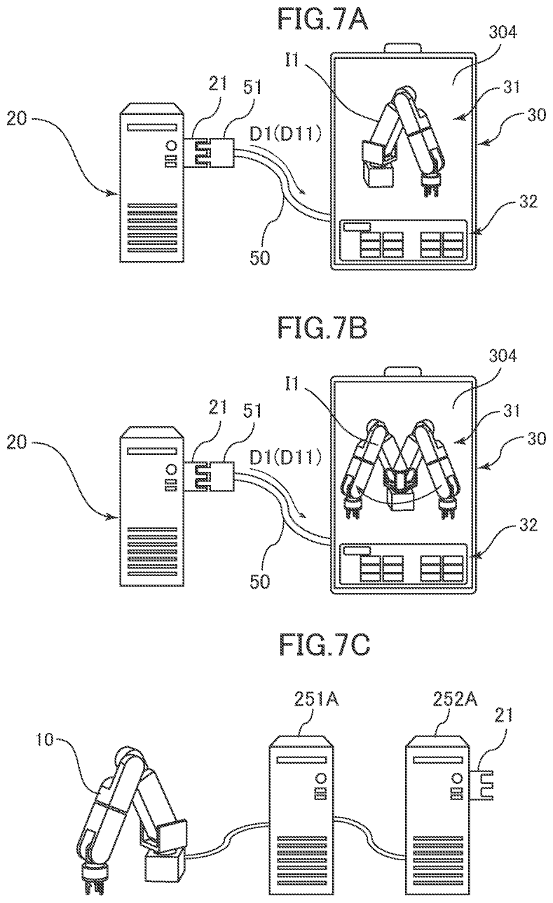

FIG. 7A is a diagram illustrating a first modification of the first embodiment. As illustrated in FIG. 7A, the information processing portion 352 of the teaching pendant 30 may display a still image, as the image I1 that corresponds to the information D1 (the image data D11), on the image display portion 31 of the touch panel display 304.

### Second Modification

FIG. 7B is a diagram illustrating a second modification of the first embodiment. As illustrated in FIG. 7B, the information processing portion 352 of the teaching pendant 30 may display an image that represents a trajectory of the robot 10, as the image I1 that corresponds to the image data D11, on the image display portion 31 of the touch panel display 304 (the trajectory of the robot 10 is based on the trajectory data DT of the robot 10). That is, the image data D11 may represent the trajectory of the robot 10, as image data that represents the motion of the robot 10 that is based on the trajectory data DT. The image data D11 may be moving-image data or still-image data. For example, as illustrated in FIG. 7B, the image I1 that represents the trajectory of the robot 10 may be created by superposing the following images on each other: an image of a 3D model of the robot 10 located at a start point of the trajectory, an image of the 3D model of the robot 10 located at an end point of the trajectory, and an image of an arrow that extends from the start point toward the end point.

Although the description has been made for the case where the image data D11 is image data of the 3D model that corresponds to the robot 10, the image data D11 is not limited to this. In another modification, the image data D11 may be captured-image data (not illustrated) obtained by capturing an image of the robot 10. In this case, the image data D11 may be moving-image data or still-image data.

The information D1 is not limited to the image data D11. For example, the information D1 may be time-series displacement data of the joints J1 to J6 of the robot 10 (that is, the time-series displacement data is the trajectory data), and the data of the 3D model of the robot 10. In this case, the information processing portion 352 of the teaching pendant 30 may receive the information D1; create the image data, based on the information D1 received by the information processing portion 352; and display an image based on the image data, on the image display portion 31 of the touch panel display 304. The image data may be moving-image data or still-image data.

In another case, the information processing portion 352 may create the image data directly from the trajectory data included in the information D1; and display an image based on the image data, on the image display portion 31 of the touch panel display 304. In this case, the information processing portion 352 may display only the time-series displacement data of the joints J1 to J6 of the robot 10, on the image display portion 31; may display only the 3D model of the robot 10, on the image display portion 31; may display only the teach point information of the robot 10, on the image display portion 31; may display only a robot program, on the image display portion 31; or may display a combination of two or more of the above-described types of data, on the image display portion 31.

### Third Modification

FIG. 7C is a diagram illustrating a third modification of the first embodiment. In the above-described first embodiment, the description has been made for the case where the CPU 201 of the controller 20 functions as the control portion 251 and the information processing portion 252. However, the present disclosure is not limited to this. For example, the robot system may include a plurality of computers 251A and 252A for a single robot 10. In this case, the CPU of the computer 251A may function as the control portion 251, and the CPU of the computer 252A may function as the information processing portion 252. That is, the computer 251A may be a dedicated machine for controlling the robot 10, and the computer 252A may be a personal computer connected to the computer 251A. In this manner, the control portion 251 and the information processing portion 252 may function in the respective computers different from each other.

### Second Embodiment

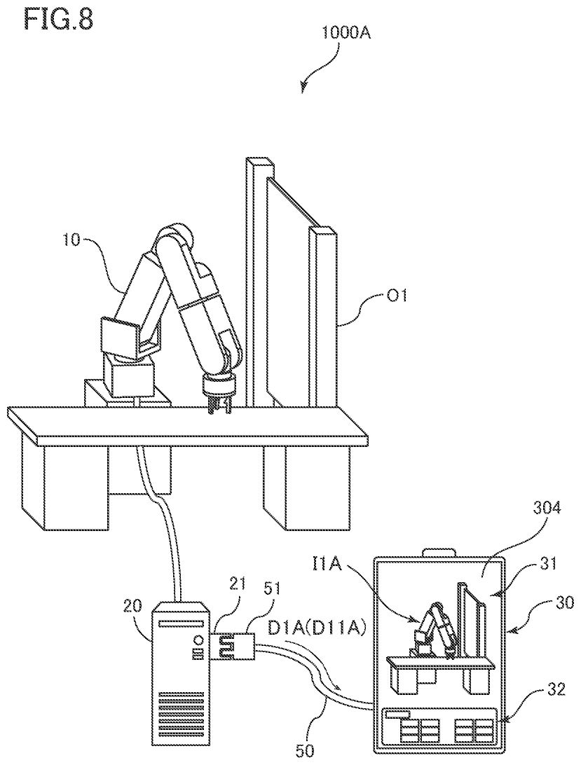

Next, a robot system of a second embodiment will be described. FIG. 8 is a diagram illustrating a robot system 1000A of the second embodiment. The configuration of the robot system 1000A of the second embodiment is the same as that of the robot system 1000 of the first embodiment. As in the first embodiment, the robot system 1000A includes a plurality of robots 10, a plurality of controllers 20, and a teaching pendant 30. Note that FIG. 8 illustrates one of the plurality of robots 10, and one of the plurality of controllers 20. A component of the robot system 1000A of the second embodiment that is the same as a component of the robot system 1000 of the first embodiment is given the same symbol as that of the component of the first embodiment, and the description thereof will be omitted.

The information processing method (control method) of the second embodiment is the same as that illustrated in the flowchart of FIG. 5, except that the data used and the image displayed on the touch panel display 304 differ from those of the first embodiment. In the second embodiment, information D1A that is first information stored in the HDD 204 in Step S10 differs from the information D1. That is, image data D11A that is first image data differs from the image data D11. That is, an image IA that is a first image displayed on the touch panel display 304 differs from the image I1.

In addition, an object O1 is disposed around the robot 10. For example, the object O1 is a table or an apparatus. The information on the object O1 around the robot 10 is included in the information D1A on the motion of the robot 10. The information on the object O1 around the robot 10 includes the relative position information that represents the positional relationship between the robot 10 and the object O1, and a 3D model that corresponds to the object O1.

The image data D11A includes image data of a 3D model that corresponds to the robot 10, and image data of a 3D model that corresponds to the object O1 around the robot 10. That is, the image I1A includes an image of the 3D model that corresponds to the robot 10, and an image of the 3D model that corresponds to the object O1 around the robot 10. The data of the 3D model that corresponds to the robot 10, the data of the 3D model that corresponds to the object O1, and the data that represents the positional relationship between the 3D model of the robot 10 and the 3D model of the object O1 are stored in the HDD 204. The image data D11A represents a positional relationship that corresponds to the actual positional relationship between the robot 10 and the object O1. The image data D11A may be still-image data or moving-image data.

The processes in the steps S20 to S40 are the same as those described in the first embodiment, except that the image data D11 is replaced with the image data D11A. Thus, the description thereof will be omitted.

In Step S50, the information processing portion 352 of the teaching pendant 30 displays the image I1A that corresponds to the information D1A (the image data D11A), on the image display portion 31 of the touch panel display 304. The image I1A may be a still image or a moving image. If the image data D11A is moving-image data, that is, if the image I1A is a moving image, an animation is displayed on the image display portion 31.

In the second embodiment, a user connects the teaching pendant 30 to a controller 20, and thereby can check the image I1A, which corresponds to the information D1A on the motion of a robot 10 connected to the controller 20, by watching the teaching pendant 30. Thus, the user can intuitively determine whether the teaching pendant 30 is connected to a controller 20 connected with a target robot 10 to be operated, by checking the image displayed on the teaching pendant 30. If the user watches the image displayed on the teaching pendant 30, and the robot 10 connected to the controller 20 is the target robot 10 to be operated, the user can directly operate the robot 10 and adjust the trajectory data DT by using the teaching pendant 30. If the user watches the image displayed on the teaching pendant 30, and the robot 10 connected to the controller 20 is not the target robot 10 to be operated, the user can disconnect the teaching pendant 30 from the controller 20, and connect the teaching pendant 30 to another controller 20.

In addition, the information processing portion 352 of the teaching pendant 30 displays an animation, as the image I1A, on the touch panel display 304. Thus, a user can visually check the relationship between the motion of the robot 10 and the object O1 around the robot 10, and can intuitively recognize the motion range of the robot 10.

Note that although the description has been made for the case where the image data D11A is image data of a model, the image data D11A is not limited to this. For example, the image data D11A may be captured-image data obtained by capturing an image of the actual robot 10 and object O1. In this case, the image data D11A may be moving-image data or still-image data. In addition, the second embodiment or a modification of the second embodiment may be combined with at least one of the first embodiment and a modification of the first embodiment.

### Third Embodiment

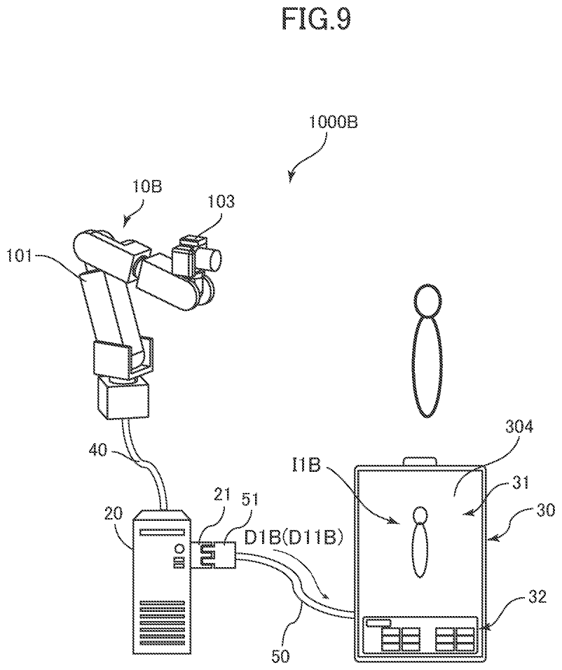

Next, a robot system of a third embodiment will be described. FIG. 9 is a diagram illustrating a robot system 1000B of the third embodiment. The robot system 1000B of the third embodiment includes a plurality of robots, a plurality of controllers, and a teaching pendant 30. Note that FIG. 9 illustrates a single robot 10B of the plurality of robots, and a single controller 20 of the plurality of controllers. In addition, a component of the robot system 1000B of the third embodiment that is the same as a component of the robot system 1000 of the first embodiment or a component of the robot system 1000A of the second embodiment is given the same symbol as that of the component of the first or the second embodiment, and the description thereof will be omitted.

The robot 10B is one example of a first robot. The robot 10B includes a robot arm 101. In addition, a camera 103 that is one example of image capture apparatuses is disposed at a predetermined portion (e.g., a distal end portion) of the robot arm 101. The camera 103 is a digital camera, and produces still-image data or moving-image data, as captured-image data, by capturing an image of an object around the robot 10B. The camera 103 is connected to the controller 20, and sends the captured-image data, produced by the camera 103, to the controller 20. Note that although the description will be made, as an example, for the camera 103 that is a digital camera, the camera 103 may be any camera as long as the camera 103 can capture an image of an object.

Next, an information processing method (control method) of the third embodiment will be described. The information processing method (control method) of the third embodiment is the same as that illustrated in the flowchart of FIG. 5, except that the data used and the image displayed on the touch panel display 304 differ from those of the first embodiment.

In Step S10, the information processing portion 252 of the controller 20 stores information D1B on the motion of the robot 10B, in the HDD 204. The information D1B is one example of first information. The information DIB on the motion of the robot 10B of the third embodiment is image data D11B on the motion of the robot 10B. The image data D11B is one example of first image data.

The image data D11B is captured-image data obtained by the camera 103 of the robot 10B capturing an image of an object. The processes in the steps S20 to S40 are the same as those described in the first embodiment, except that the image data D11 is replaced with the image data D11B. Thus, the description thereof will be omitted.

In Step S50, the information processing portion 352 of the teaching pendant 30 displays an image I1B that corresponds to the image data D11B, on the image display portion 31 of the touch panel display 304. The image I1B is one example of a first image. In this manner, a still image or a moving image of an object around the robot 10B, captured by the camera 103, is displayed on the image display portion 31.

In the third embodiment, a user connects the teaching pendant 30 to a controller 20, and thereby can check the image I1B, which corresponds to the information DIB on the motion of a robot 10B connected to the controller 20, by watching the teaching pendant 30. Thus, the user can intuitively determine whether the teaching pendant 30 is connected to a controller 20 connected with a target robot 10B to be operated, by checking the image displayed on the teaching pendant 30. In addition, the image I1B is an image of an object around the robot 10B, captured by the camera 103. The camera 103 captures images in various directions, depending on the motion (posture) of the robot 10B. Thus, a user can easily determine which robot is a target robot 10B to be operated. Thus, a user can intuitively determine whether the teaching pendant 30 is connected to a controller 20 connected with a target robot 10B to be operated, by only watching the image displayed on the teaching pendant 30.

If the user watches the image displayed on the teaching pendant 30, and the robot 10B connected to the controller 20 is the target robot to be operated, the user can directly operate the robot 10B and adjust the trajectory data by using the teaching pendant 30. If the user watches the image displayed on the teaching pendant 30, and the robot 10B connected to the controller 20 is not the target robot to be operated, the user can disconnect the teaching pendant 30 from the controller 20, and connect the teaching pendant 30 to another controller 20.

Note that although the description has been made for the case where the camera 103 is fixed to the robot 10B, the present disclosure is not limited to this. For example, the camera 103 may be fixed to an object other than the robot 10B. That is, the image data obtained by the camera 103 capturing an image of an object has only to be image data related to the motion of the robot 10B. For example, the image data may be obtained by capturing an image of the robot 10B.

In addition, the third embodiment or a modification of the third embodiment may be combined with at least one of the first embodiment, a modification of the first embodiment, the second embodiment, and a modification of the second embodiment. For example, in addition to the image I1B, the image I1 or I1A may be displayed on the image display portion 31.

### Fourth Embodiment

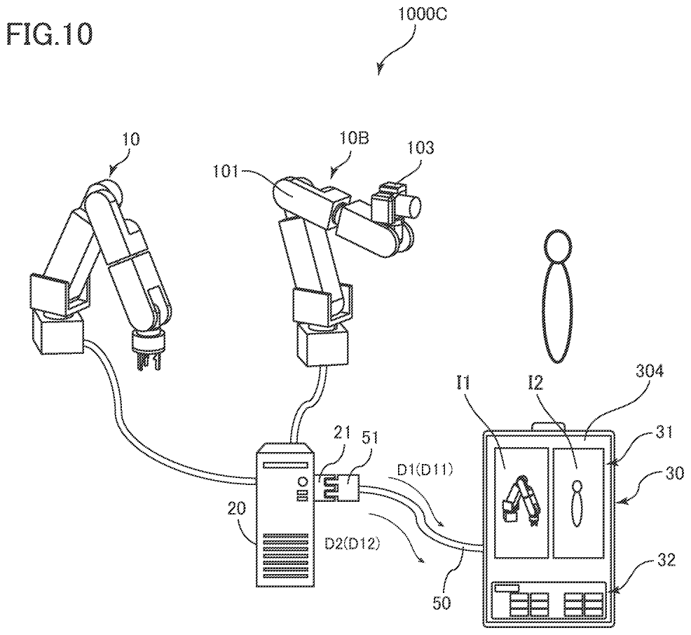

Next, a robot system of a fourth embodiment will be described. FIG. 10 is a diagram illustrating a robot system 1000C of the fourth embodiment. The robot system 1000C of the fourth embodiment includes a plurality of robots, a plurality of controllers, and a teaching pendant 30. In the present embodiment, two or more robots of the plurality of robots are connected to a single controller of the plurality of controllers. FIG. 10 illustrates two robots 10 and 10B, as an example of the two or more robots; and a single controller 20, as an example of the single controller. A component of the robot system 1000C of the fourth embodiment that is the same as a component of any of the robot systems 1000 to 1000B of the first to the third embodiments is given the same symbol as that of the component of any of the first to the third embodiments, and the description thereof will be omitted.

The robots 10 and 10B are connected to the controller 20. The robot 10 is one example of a first robot, and the robot 10B is one example of a second robot. The robot 10 may have the same configuration as that of the robot of the first embodiment. The robot 10B may have the same configuration as that of the robot of the third embodiment, and has a camera 103 disposed on the robot arm 101. Note that although the description will be made, as an example, for a case where the two robots 10 and 10B are connected to the single controller 20, the present disclosure is not limited to this. For example, three or more robots may be connected to the controller 20. In addition, although the camera 103 is attached to one of the two robots 10 and 10B, the present disclosure is not limited to this.

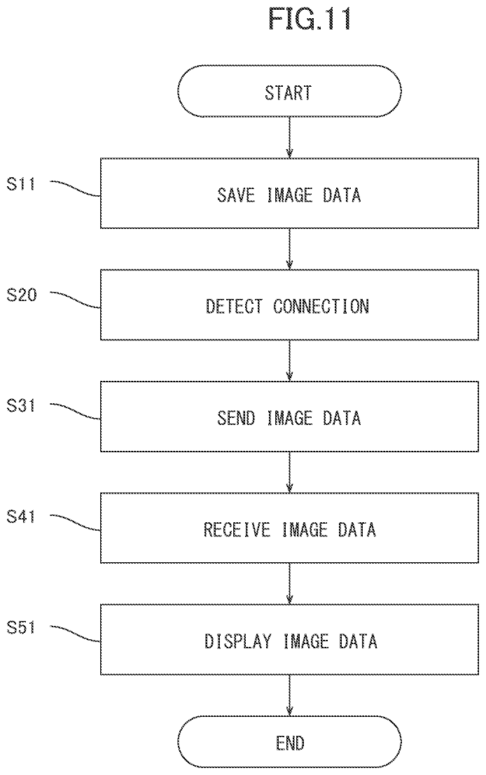

The following description will be made for a case where the trajectory data of the robot 10 has already been registered in the controller 20, that is, the trajectory data of the robot 10 is stored in the HDD 204. FIG. 11 is a flowchart of an information processing method (control method) of the fourth embodiment. In Step S11, the information processing portion 252 registers information D1 and D2 in the HDD 204, in advance. The information D1 is one example of first information. The information D2 is one example of second information. Trajectory data DT of the robot 10 is registered (stored) in the HDD 204, in advance.

In Step S11, the information processing portion 252 stores the information D1 on the motion of the robot 10 and the information D2 on the motion of the robot 10B, in the HDD 204. The information D1 on the motion of the robot 10 of the fourth embodiment is image data D11 on the motion of the robot 10. The image data D11 is one example of first image data. The information D2 on the motion of the robot 10B of the fourth embodiment is image data D12 on the motion of the robot 10B. The image data D12 is one example of second image data.

The image data D11 is image data of a 3D model that corresponds to the robot 10. For example, the image data D11 is moving-image data, or an animation, of the 3D model of the robot 10 that moves in accordance with the trajectory data DT. The image data D12 is captured-image data obtained by the camera 103 of the robot 10B capturing an image of an object.

The information D1 on the motion of the robot 10 and the information D2 on the motion of the robot 10B are stored in the HDD 204, separately from each other. In this case, each of the information D1 and D2 may be associated with the information on the identification number of a corresponding robot.

Since the process of Step S20 is the same as the process of Step S20 of FIG. 5 described in the first embodiment, the description of Step S20 will be omitted.

In Step S31, if the teaching pendant 30 is connected to the controller 20, the information processing portion 252 of the controller 20 sends the information D1 on the motion of the robot 10 that may be a target robot to be operated by the teaching pendant 30, to the teaching pendant 30. The information D1 is the image data D11. That is, if the teaching pendant 30 is connected to the controller 20 (the connection serves as a trigger), the information processing portion 252 sends the image data D11 stored in the HDD 204, to the teaching pendant 30. Examples of the method of sending the image data include the serial communication, the TCP/IP communication, and the UDP communication; but the method is not limited to these.

In addition, in Step S31, if the teaching pendant 30 is connected to the controller 20, the information processing portion 252 of the controller 20 sends the information D2 on the motion of the robot 10B that may be a target robot to be operated by the teaching pendant 30, to the teaching pendant 30. The information D2 is the image data D12. That is, if the teaching pendant 30 is connected to the controller 20 (the connection serves as a trigger), the information processing portion 252 sends the image data D12 stored in the HDD 204, to the teaching pendant 30. Examples of the method of sending the image data includes the serial communication, the TCP/IP communication, and the UDP communication; but the method is not limited to these.

Note that at least one portion of each of the information D1 and D2 may be sent to the teaching pendant 30.

In Step S41, the information processing portion 352 of the teaching pendant 30 receives the information D1, or the image data D11, and the information D2, or the image data D12, from the controller 20. The information processing portion 352 of the teaching pendant 30 may store the image data D11 and D12, received by the information processing portion 352, in a storage; or may store the image data D11 and D12 temporarily in a memory. The information D1 and the information D2 are stored in the storage or the memory, separately from each other.

In Step S51, the information processing portion 352 of the teaching pendant 30 displays an image I1 that corresponds to the information D1 (the image data D11), on the image display portion 31 of the touch panel display 304. The image I1 is one example of a first image.

In addition, in Step S51, the information processing portion 352 of the teaching pendant 30 displays an image I2 that corresponds to the information D2 (the image data D12), on the image display portion 31 of the touch panel display 304. The image I2 is one example of a second image.

In Step S51, the information processing portion 352 may also display an image that represents the identification number of each of the robots 10 and 10B, on the touch panel display 304.

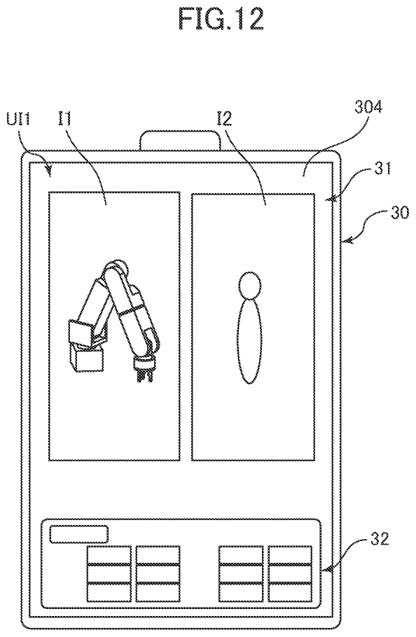

FIG. 12 is a diagram illustrating an example of an image displayed on the teaching pendant 30 of the fourth embodiment. In Step S51, upon receiving the information D1 and D2 (the image data D11 and D12) from the controller 20, the information processing portion 352 of the teaching pendant 30 displays a user interface image UI1 on the touch panel display 304. The user interface image UI1 is an image for receiving the selection of any one of the plurality of robots 10 and 10B, to be operated.

The user interface image UI1 includes the image I1 that corresponds to the information D1 (the image data D11), and the image I2 that corresponds to the information D2 (the image data D12). That is, the information processing portion 352 displays the images I1 and I2 in the user interface image UI1 so that a user can select any one of the images I1 and I2. If a user touches the image I1, the robot 10 is selected as a target robot to be operated; if the user touches the image I2, the robot 10B is selected as a target robot to be operated.

Note that the information processing portion 252 may send one portion of the information D1 in step S31, and the information processing portion 352 may receive the one portion of the information D1 in Step S41. In this case, if the image I1 is selected in the user interface image UI1 displayed, in Step S51, on the touch panel display 304 by the information processing portion 352, the information processing portion 352 may request the information processing portion 252 to send the remaining data of the information D1. The information processing portion 252 may send the remaining data of the information D1 to the information processing portion 352, in response to the request; and the information processing portion 352 may receive the remaining data of the information D1.

In addition, the information processing portion 252 may send one portion of the information D2 in step S31, and the information processing portion 352 may receive the one portion of the information D2 in Step S41. In this case, if the image I2 is selected in the user interface image UI1 displayed, in Step S51, on the touch panel display 304 by the information processing portion 352, the information processing portion 352 may request the information processing portion 252 to send the remaining data of the information D2. The information processing portion 252 may send the remaining data of the information D2 to the information processing portion 352, in response to the request; and the information processing portion 352 may receive the remaining data of the information D2.

As described above, in the fourth embodiment, a user connects the teaching pendant 30 to a controller 20, and thereby can check the images I1 and I2, which corresponds to the information on the motion of the robots 10 and 10B connected to the controller 20, by watching the teaching pendant 30. That is, the user can intuitively determine that the teaching pendant 30 has been connected to the controller 20 connected to the robots 10 and 10B.

In addition, since the information processing portion 352 displays the images I1 and I2 on the touch panel display 304 such that the images I1 and I2 are arranged adjacent to each other, a user can intuitively determine which of the robots 10 and 10B is a target robot to be operated.

In addition, a user can intuitively select a target robot to be operated, from among the robots 10 and 10B that may be a target robot to be operated, by selecting the image I1 or I2 in the user interface image UI1.

Note that the fourth embodiment or a modification of the fourth embodiment may be combined with at least one of the first embodiment, a modification of the first embodiment, the second embodiment, a modification of the second embodiment, the third embodiment, and a modification of the third embodiment. For example, the image of the information on the motion of the robot is not limited to the animation of the robot or the captured image. The image may be a still image of the robot, or a still image of a 3D model that corresponds to the robot, as in the first modification of the first embodiment. In another case, the image may be an image that represents the trajectory of the robot, as in the second modification of the first embodiment. In another case, as in the second embodiment, the image may include an image of an object around the robot, or an image of a 3D model that corresponds to an object around the robot.

### Fifth Embodiment

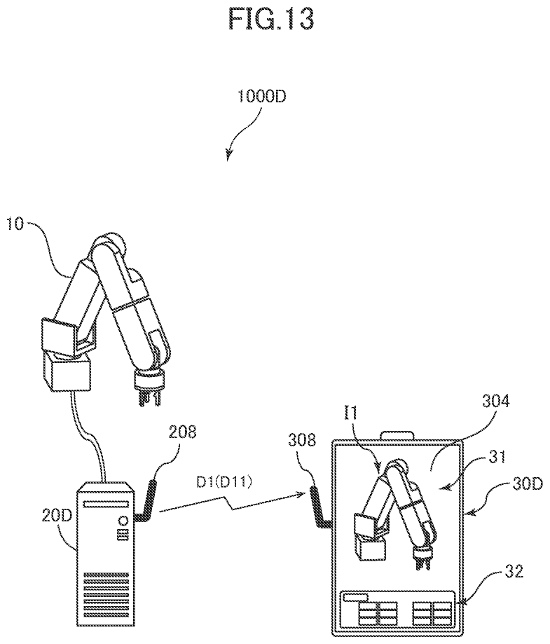

Next, a robot system of a fifth embodiment will be described. FIG. 13 is a diagram illustrating a robot system 1000D of the fifth embodiment. The robot system 1000D of the fifth embodiment includes a plurality of robots, a plurality of controllers, and a teaching pendant 30D that is one example of operating devices. Note that FIG. 13 illustrates a single robot 10 of the plurality of robots, and a single controller 20D of the plurality of controllers. The controller 20D is one example of an information processing apparatus. A component of the robot system 1000D of the fifth embodiment that is the same as a component of any of the robot systems 1000 to 1000C of the first to the fourth embodiments is given the same symbol as that of the component of any of the first to the fourth embodiments, and the description thereof will be omitted.

In the first to the fourth embodiments, the description has been made for the case where the controller and the teaching pendant are connected with each other by using a wired connection method. In the fifth embodiment, however, the description will be made for a case where the controller 20D and the teaching pendant 30D are connected with each other by using a wireless connection method. Note that the robot 10 has the same configuration as that of the robot 10 described in the first embodiment.

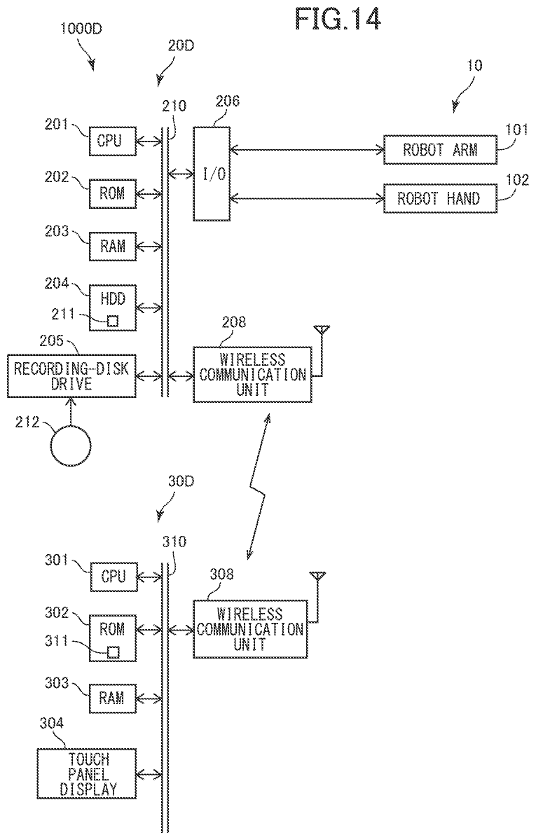

FIG. 14 is a block diagram illustrating a control system of the robot system 1000D of the fifth embodiment. The controller 20D is a computer, and like the controller 20 of the first embodiment, the controller 20D includes a CPU 201, a ROM 202, a RAM 203, an HDD 204, a recording-disk drive 205, and an I/O 206. In addition, the controller 20D includes a wireless communication unit 208. The CPU 201, the ROM 202, the RAM 203, the HDD 204, the recording-disk drive 205, the I/O 206, and the wireless communication unit 208 are connected with each other via a bus 210 such that they can transmit data to each other. The robot arm 101 and the robot hand 102 are connected to the I/O 206. The HDD 204 stores a program 211 to be executed by the CPU 201. By executing the program 211, the CPU 201 functions as the control portion 251 and the information processing portion 252 illustrated in FIG. 4A. The wireless communication unit 208 is one example of a communication portion. The wireless communication unit 208 includes an antenna and a communication circuit.

The teaching pendant 30D is a computer, and like the teaching pendant 30 of the first embodiment, the teaching pendant 30D includes a CPU 301, a ROM 302, a RAM 303, and a touch panel display 304. In addition, the teaching pendant 30D includes a wireless communication unit 308. The CPU 301, the ROM 302, the RAM 303, the touch panel display 304, and the wireless communication unit 308 are connected with each other via a bus 310 such that they can transmit data to each other. The ROM 302 stores a program 311 to be executed by the CPU 301. By executing the program 311, the CPU 301 functions as the information processing portion 352 illustrated in FIG. 4B. The wireless communication unit 308 is one example of a communication portion. The wireless communication unit 308 includes an antenna and a communication circuit. The wireless communication unit 208 of the controller 20D and the wireless communication unit 308 of the teaching pendant 30D can perform wireless communication with each other.

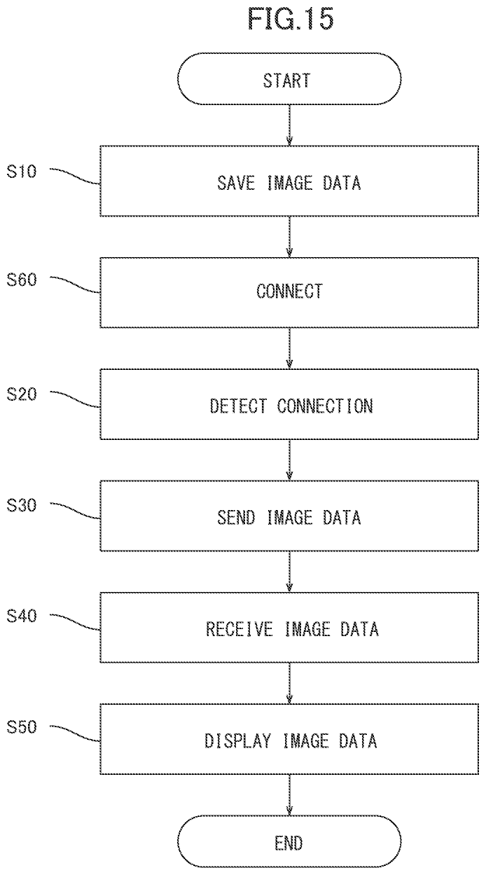

FIG. 15 is a flowchart of an information processing method (control method) of the fifth embodiment. Since the process of Step S10 is the same as the process of Step S10 of FIG. 5, the description of Step S10 will be omitted. In Step S60, the teaching pendant 30D is connected to the controller 20D by the operation performed by a user.

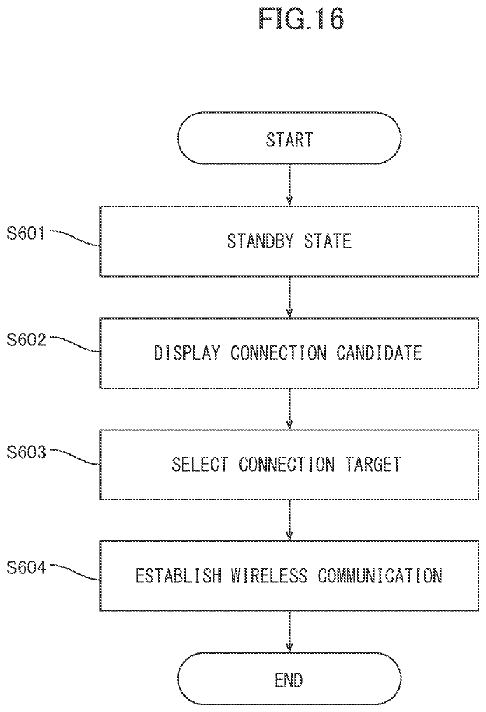

Next, Step S60 will be described specifically. FIG. 16 is a flowchart illustrating a procedure for establishing the wireless communication of the fifth embodiment.

In Step S601, the state of the wireless communication unit 208 of the controller 20D is set to a standby state. For example, if a button or a user interface disposed on the controller 20D is operated by a user, the state of the wireless communication unit 208 is set to the standby state.

In Step S602, the information processing portion 352 of the teaching pendant 30D displays on the touch panel display 304, the name and ID of the controller that is in the standby state (the controller is displayed as a connection candidate). For example, if WiFi (registered trademark) is used, the information processing portion 352 displays on the touch panel display 304, the name and ID of a controller that exists in the same network as that where the teaching pendant 30D exists. If Bluetooth (registered trademark) is used, the information processing portion 352 displays on the touch panel display 304, the name and ID of a controller that is in a communication range in which the wireless communication unit 308 can communicate with the controller, and that is in the standby state. Note that if the teaching pendant 30D can be connected to a plurality of controllers, the information processing portion 352 displays on the touch panel display 304, the name and ID of each of the plurality of controllers, as connection candidates.

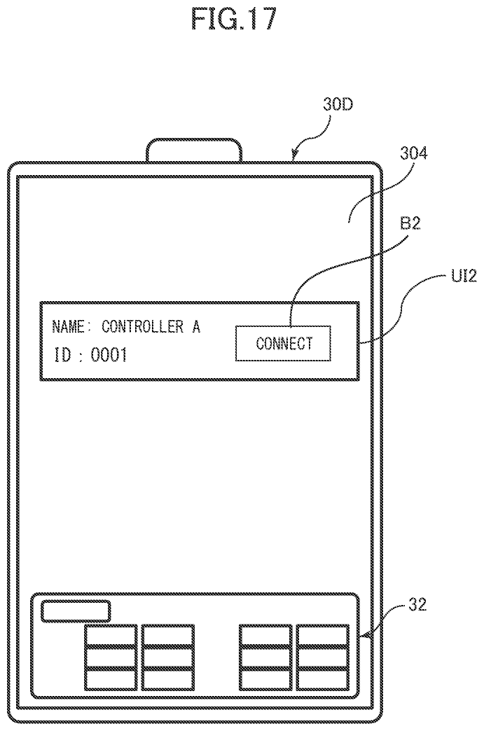

In Step S603, the information processing portion 352 of the teaching pendant 30D accepts the selection of a controller (which is a connection target) performed by a user. FIG. 17 is a diagram illustrating an image displayed on the teaching pendant 30D of the fifth embodiment. The information processing portion 352 displays a user interface image UI2 on the touch panel display 304. The user interface image UI2 is a user interface image for accepting an instruction for establishing the wireless communication with the controller 20D. For example, in the user interface image UI2, a name “controller A” and an ID “0001” of the controller 20D are displayed. The controller 20D is a connection candidate in the standby state.

The user interface image UI2 also includes a connection button B2. The connection button B2 can be operated by a user for wirelessly connecting the teaching pendant 30D to the controller 20D that is a connection candidate. If the information processing portion 352 detects that the connection button B2 displayed on the touch panel display 304 is touched by a user, the information processing portion 352 causes the wireless communication unit 308 to send a connection request to the controller 20D. The connection request can be recognized by only the controller 20D that is a connection target. For example, the connection request is added with an ID, so that the connection request can be recognized by the controller 20D.

Note that if the teaching pendant 30D can be connected to a plurality of controllers, the information processing portion 352 displays on the touch panel display 304, a plurality of user interface images UI2 that correspond to the plurality of controllers. With the user interface images UI2 displayed on the touch panel display 304, a user can select one of the plurality of controllers, as a connection target.

In Step S604, the wireless communication unit 208 of the controller 20D receives the connection request, so that the wireless communication unit 308 of the teaching pendant 30D and the wireless communication unit 208 of the controller 20D establish the wireless communication with each other. In this manner, the teaching pendant 30D is connected to the controller 20D. In the connection state, the wireless communication is established between the wireless communication unit 308 of the teaching pendant 30D and the wireless communication unit 208 of the controller 20D.

Since the processes of the steps S20 to S50 are the same as the processes of the steps S20 to S50 of FIG. 5, the description of the steps S20 to S50 will be omitted.

As described above, in the fifth embodiment, if the teaching pendant 30D is wirelessly connected to the controller 20D, a user can check the image I1, which corresponds to the information D1 on the motion of the robot 10 connected to the controller 20D, by watching the touch panel display 304 of the teaching pendant 30D. Thus, the user can intuitively determine that the teaching pendant 30D has been connected to the controller 20D connected to the robot 10 to be operated.

Note that the fifth embodiment or a modification of the fifth embodiment may be combined with at least one of the first embodiment, a modification of the first embodiment, the second embodiment, a modification of the second embodiment, the third embodiment, a modification of the third embodiment, the fourth embodiment, and a modification of the fourth embodiment.

The present disclosure is not limited to the above-described embodiments, and the embodiments may be variously modified within the technical concept of the present disclosure. For example, at least two of the above-described plurality of embodiments and modifications may be combined with each other. In addition, the effects described in the present embodiment are merely the most suitable effects produced by the embodiments of the present disclosure. Thus, the effects by the embodiments of the present disclosure are not limited to those described in the present embodiment.

In the above-described embodiments, the description has been made for the case where the robot is a vertically articulated robot. However, the present disclosure is not limited to this. For example, the robot may be a horizontally articulated robot, a parallel link robot, or a Cartesian coordinate robot.

In addition, the above-described embodiments can be applied to any machine that can automatically perform expansion and contraction motion, bending and stretching motion, up-and-down motion, right-and-left motion, pivot motion, or combination motion thereof, depending on information data stored in a storage device of a controller.

In addition, although the description has been made for the case where the operating device is a teaching pendant, the present disclosure is not limited to this. For example, the operating device may be a tablet computer, a laptop computer, or a smartphone.

The present disclosure allows a user to intuitively identify a target robot to be operated by the user.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-040537, filed Mar. 15, 2023, which is hereby incorporated by reference herein in its entirety.

What is claimed is:

1. An information processing apparatus comprising:
an information processing portion,
wherein the information processing portion is configured to send first information to an operating device if the operating device is connected to the information processing apparatus, the first information being information on a motion of a first robot that may be a target robot to be operated by the operating device.

2. The information processing apparatus according to claim 1, wherein the first information includes first image data on a motion of the first robot.

3. The information processing apparatus according to claim 2, wherein the first image data includes image data of the first robot or image data of a model that corresponds to the first robot.

4. The information processing apparatus according to claim 3, wherein the first image data includes image data of an object around the first robot or image data of a model that corresponds to the object.

5. The information processing apparatus according to claim 2, wherein the first image data includes captured-image data obtained by an image capture apparatus capturing an image, the image capture apparatus being disposed on the first robot.

6. The information processing apparatus according to claim 2, further comprising a storage portion,
wherein the storage portion is configured to store trajectory data, and
wherein the first image data includes image data that represents a motion of the first robot based on the trajectory data.

7. The information processing apparatus according to claim 2, wherein the first image data is still-image data or moving-image data.

8. The information processing apparatus according to claim 1, wherein the information processing portion is configured to send the first information and second information to the operating device if the operating device is connected to the information processing apparatus, the first information being information on a motion of the first robot that may be a target robot to be operated by the operating device, the second information being information on a motion of a second robot that may be a target robot to be operated by the operating device.

9. The information processing apparatus according to claim 8, wherein the second information includes second image data on a motion of the second robot.

10. The information processing apparatus according to claim 1, further comprising:
a connection terminal to which the operating device is configured to be connected via wire,
wherein a state where the operating device is connected to the information processing apparatus includes a state where the operating device is connected to the connection terminal via wire.

11. The information processing apparatus according to claim 1, further comprising:
a communication portion configured to perform wireless communication with the operating device,
wherein a state where the operating device has been connected to the information processing apparatus includes a state where the communication portion has established the wireless communication with the operating device.

12. An operating device comprising:
an information processing portion; and
a display portion,
wherein the information processing portion is configured to display a first image on the display portion if the information processing portion receives first information from an information processing apparatus, the first image being an image that corresponds to the first information, the first information being information on a motion of a first robot that may be a target robot to be operated.

13. The operating device according to claim 12, wherein the first image includes an image of the first robot or an image of a model that corresponds to the first robot.

14. The operating device according to claim 13, wherein the first image includes an image of an object around the first robot or an image of a model that corresponds to the object.

15. The operating device according to claim 12, wherein the first image includes a captured image obtained by an image capture apparatus capturing an image, the image capture apparatus being disposed on the first robot.

16. The operating device according to claim 12, wherein the first image includes an image that represents a motion of the first robot based on trajectory data.

17. The operating device according to claim 12, wherein the first image is a still image or a moving image.

18. The operating device according to claim 12, wherein the information processing portion is configured to display the first image and a second image on the display portion if the information processing portion receives the first information and second information from the information processing apparatus, the first information being information on a motion of the first robot that may be a target robot to be operated, the second information being information on a motion of a second robot that may be a target robot to be operated, the first image being an image that corresponds to the first information, the second image being an image that corresponds to the second information.

19. The operating device according to claim 12, wherein the information processing portion is configured to display a user interface image on the display portion if the information processing portion receives the first information and second information from the information processing apparatus, the first information being information on a motion of the first robot that may be a target robot to be operated, the second information being information on a motion of a second robot that may be a target robot to be operated, the user interface image being configured to accept a selection of a target robot to be operated, the target robot being selected from the first robot and the second robot.

20. The operating device according to claim 19, wherein the user interface image includes the first image that corresponds to the first information and a second image that corresponds to the second information.

21. A robot system comprising:
the information processing apparatus according to claim 1;
the first robot; and
the operating device.

22. The robot system according to claim 21, comprising:
at least two of the first robot; and
at least two of the information processing apparatus that correspond to the at least two of the first robot,
wherein if the operating device is connected to a predetermined information processing apparatus of the at least two of the information processing apparatus, the predetermined information processing apparatus sends the first information to the operating device, the first information being information on a motion of the first robot that corresponds to the predetermined information processing apparatus.

23. An information processing method of an information processing apparatus, the method comprising:
sending first information to an operating device if the operating device is connected to the information processing apparatus, the first information being information on a motion of a first robot that may be a target robot to be operated by the operating device.

24. A control method of an operating device, the method comprising:
displaying a first image on a display portion if the operating device receives first information from an information processing apparatus connected to the operating device, the first information being information on a motion of a first robot that may be a target robot to be operated, the first image being an image that corresponds to the first information.

25. A method of manufacturing products by using the robot system according to claim 21.

26. A computer-readable non-transitory recording medium storing a program that causes a computer to execute the information processing method according to claim 23.
